(19) United States
(12) Patent Application Publication
(10) Pub. No.: US 2009/0188840 A1
(43) Pub. Date: Jul. 30, 2009

(54) Screen basket for securing inlets or outlets of tanks

(75) Inventor: Rainer Ansperger, Gladbeck (DE)

Correspondence Address: HARNESS, DICKEY & PIERCE, P.L.C., P.O. BOX 828, BLOOMFIELD HILLS, MI, 48303, US

(73) Assignee: AE & E Lentjes GmbH

(21) Appl. No.: 12/319,476

(22) Filed: Jan. 8, 2009

(30) Foreign Application Priority Data
Jan. 26, 2008 (DE) 10 2008 006 173.5

(51) Int. Cl. B01D 35/00; B07B 1/46

(52) U.S. Cl. 209/259; 209/409

(57) ABSTRACT

The present invention relates to a screen basket for securing inlets or outlets of tanks, which screen basket can be easily mounted and in particular comprises a high resistance against corrosive surroundings.

### BACKGROUND OF THE INVENTION

1. Technical Field

The present invention relates to a screen basket for securing inlets or outlets of tanks. In particular, the present invention relates to a screen basket that can be mounted in a simple way.

2. Discussion

Screen baskets for securing inlets or outlets of tanks serve to avoid the penetration of items into the inlets or outlets of tanks, which items can lead to occlusions or damages in the inlets or outlets. In industrial big scale installations, such as for example scrubbing towers of flue gas desulphurization units of power stations, screen baskets also have to be dimensioned in a size corresponding to the large cross sections of the inlets or outlets. In industrial installations, such as the mentioned flue gas purification units, such screen baskets are also often submitted to corrosive surroundings, such that the screen baskets and the fastenings of the screen baskets have to be made of material that is resistant against the corrosive influences. Usually, stainless steels or steel components provided with a rubber film are used for this.

However, the use of stainless steels, such as for example Hastelloy is extremely expensive, since stainless steels have, in particular recently, been dealt with at very high prices. Since it also requires extremely high efforts to apply the rubber film, it is also very expensive and time consuming to manufacture corresponding screen baskets and holding devices in steel coated with rubber, since the rubber film has to be completely closed and can accordingly only be applied after the mounting of the screen baskets in the tanks.

Thus, hitherto it has for example been common in the state of the art to design screen baskets for securing inlets or outlets in scrubbers of flue gas desulphurization units in the form of grids which are screwed onto holding supports made of stainless steel or holding supports made of rubber coated steel. If herein holding supports made of rubber coated steel are used, the holding supports have to present a completely continuous rubber film, such that also the through holes of the supports for receiving the fastening screws of the screen plates have to be coated with rubber. Furthermore, corrosion resistant materials have also to be chosen for screwing, wherein a rubber film that assures a corrosion prevention of the screwing can usually not be realized, such that stainless steel screws have to be usually used as fastening screws.

During the mounting itself, the rubber film can be damaged due to lacking attention, in particular in the area of the through holes of the holding supports, whereby the steel material beneath the rubber film is no more sufficiently protected against corrosion and thus corrosion damages might happen in these areas in the course of the operation.

The screen baskets that have been hitherto known in the state of the art are essentially sieve grids made of synthetic material, such as polypropylene or glass fiber reinforced plastic, which grids are fastened on a stable, rubber coated steel sub-construction by means of stainless steel screws, stainless steel disks and stainless steel nuts. Hereby, enormous costs for the fastening means are caused, which are furthermore subject to strong market dependent variations. The sub-constructions made of rubber-coated steel are also very expensive, since the fastening holes have to be formed such that they are appropriate for being coated with a rubber film, whereby large through holes are generated which in turn entail very large stainless steel disks for reducing the pressure on the rubber film.

The structure is similar if materials like glass fiber reinforced plastic are used. However, the mounting of the screen baskets made of glass fiber reinforced plastic is still more difficult due to the often bad accessibility at the mounting place.

### SUMMARY OF THE INVENTION

In consideration of the above statements it is the object of the present invention to provide a screen basket for securing inlets or outlets of tanks, in particular for the use in corrosive surroundings, which screen basket can be easily mounted and manufactured at low costs while furthermore presenting a high corrosion resistance.

This aim is achieved by a screen basket for securing inlets or outlets of tanks, wherein the screen basket comprises two guide angles that can be mounted on the tank wall and one screen element, on which portions are provided that engage into the guide angles, wherein the guide angles are positioned with respect to each other such that the screen element can be inserted into the guide angles and be fixed above the inlets or outlet.

Herein, the screen element can have the form of a screen plate that forms a screen surface which is essentially parallel to the plane extending between the guide angles.

In one embodiment of the screen basket according to the invention, the sieve element comprises, at least in partial areas, screen surfaces that are anti-parallel with respect to the plane extending between the guide angles. Thus, the screen basket can for example have a substantially triangular cross section with two sieve elements that are placed in an angled manner with respect to each other.

According to the invention, the sieve elements can be made of synthetic materials, such as for example polypropylene or a polypropylene blend, wherein these ones can optionally also comprise a metal core.

For the fixation of the screen elements inserted into the guide angles, the screen elements can be fixed with a fixation clamp that can also be inserted into the guide angles.

In another embodiment of the screen basket according to the invention for securing inlets or outlets of tanks, at least two sieve elements can be inserted into the guide angles in a superimposed manner, in order to obtain individual screen elements that can be easily manipulated also in case of large inlet or outlet cross sections. The individual screen elements can then be connected to each other. For connecting the screen elements, in particular safety clamps, safety bolts or also welds are suitable.

Due to the corrosion resistance of the connection means of the screen elements which is required in corrosive surroundings, for example plastic sheathed metal clamps or corresponding plastic sheathed safety bolts can be used. If the screen elements used according to the invention are made of synthetic materials, these ones can be connected to each other by means of a plastic weld.

The guide angles for receiving the portions of the screen elements that engage into the guide angles can also be made of synthetic material or of stainless steel or of rubber coated steel. Thanks to the simple design of the guide angles without requiring through holes for the fixation of the screen elements, it is easy to coat the steel guide angles with rubber also at the assembly place. If the guide angles are made of stainless steel, the material requirements are clearly reduced in comparison to the hitherto usual embodiments, since a plurality of components, such as for example disks and screws, can be omitted.

The following exemplary embodiment shows a screen basket according to the invention for securing inlets or outlets in a flue gas scrubber of a flue gas desulphurization unit.

### BRIEF DESCRIPTION OF THE DRAWINGS

FIG. 1 shows a cross section through an absorber tank of a flue gas purification unit, in which tank a screen basket according to the invention is installed.

FIG. 2 shows a detailed drawing of a screen basket according to the invention.

FIG. 3 shows a screen element of a screen basket according to the invention.

FIG. 4 shows several superimposed screen elements in a screen basket according to the invention.

### DESCRIPTION OF THE PREFERRED EMBODIMENTS

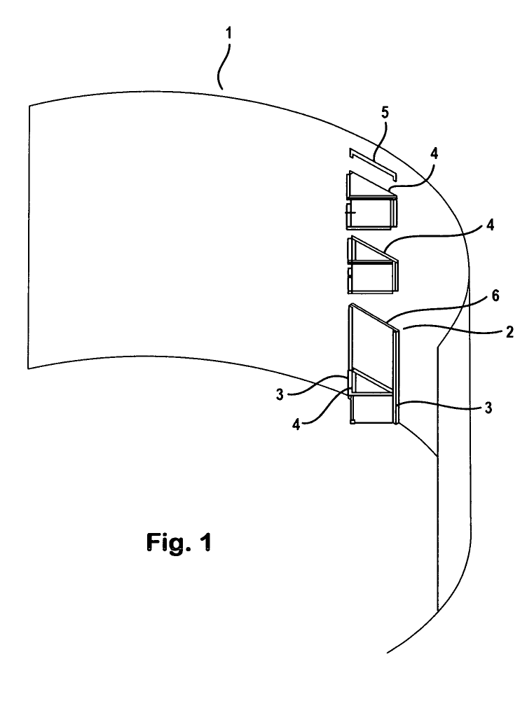

In FIG. 1 an absorber tank 1 of a flue gas scrubber in an incinerating plant is shown. In the absorber tank 1, a screen basket 2 according to the invention is shown in front of an absorber solution outlet. The screen basket 2 according to the invention comprises guide angles 3, which are mounted in parallel to each other on the absorber tank wall. A holding sheet metal 6 connecting the guide angles 3 is provided in the head section of the guide angles 3. Screen elements 4 can be inserted into the guide angles 3, which screen elements can be fixed by inserting a safety clamp after insertion of the last screen element 4.

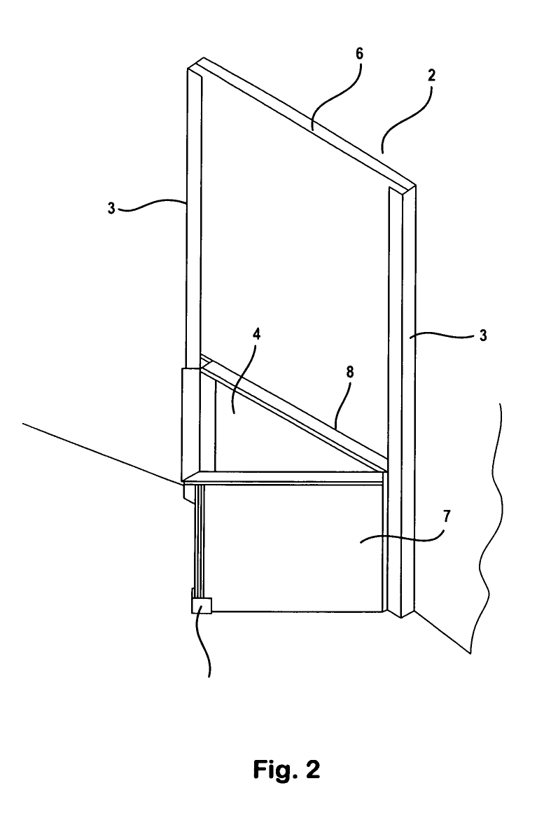

FIG. 2 shows a detailed drawing of a screen basket 2 according to the invention. In the shown embodiment, the sieve element 4 comprises two screen surfaces 7 located in an angular manner with respect to each other, which are connected to each other at the bordering of the two screen surfaces 7. Herein, the screen surfaces can be welded to each other or be connected to each other by means of suitable fixation angles. At the open end of the extending triangle, the screen surfaces are connected to each other by means of a holding brace 8, in order to assure a sufficient stability of the screen element. As far as the outlet to be protected by the screen basket according to the invention is located in the bottom area of the tank, a safety bracket 9 can be provided at the bottom of the absorber tank, into which the point of the triangle formed by the two screen surfaces 7 engages. Hereby, an additional fixation and stabilization of the screen element is obtained.

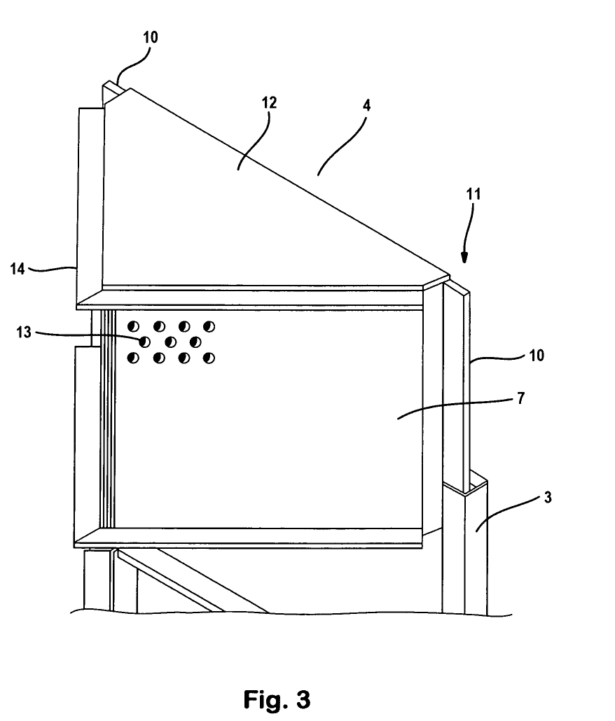

FIG. 3 shows a detailed view of a screen element 4 provided in a screen basket according to the invention. The screen element 4 comprises laterally arranged bearings 10 which can engage into the guiding brackets 3 in the insertion direction 11 during insertion of the screen element 4 into the guiding brackets 3. The screen surfaces 7 comprise screen bores 13, through which the absorption liquid can flow into the outlet to be protected. In the shown embodiment, the sieve elements 4 comprise throats 14 in the top and bottom areas of the screen surfaces 7, which projections serve to stabilize the screen element 4. In the top area, the embodiment of a screen element 4 shown in FIG. 3 comprises an end surface 12 covering the cross section. According to the invention, this end surface 12 can be either a screen surface or have the form of a reflux valve, in order to avoid damaging of the screen basket 2 in case of a liquid back flash.

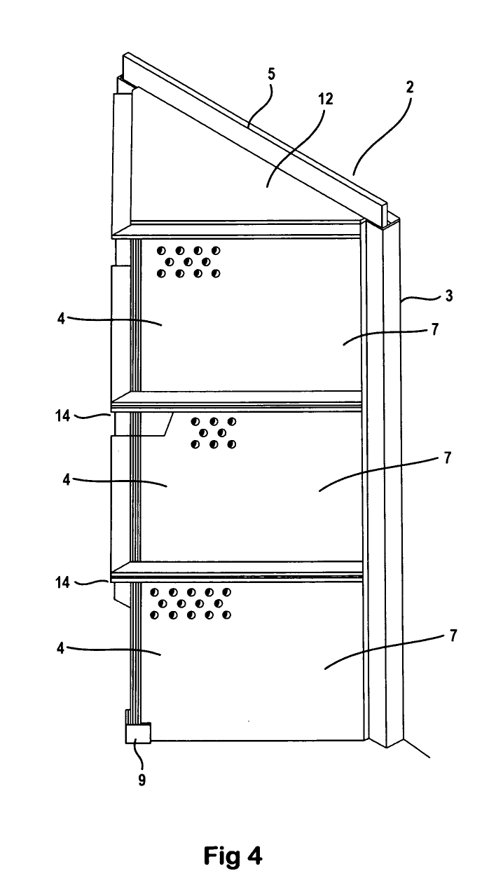

FIG. 4 shows a finally assembled screen basket 2 according to the invention, which is composed of three superimposed screen elements 4. In the bottom area, the lowest screen element 4 is secured by means of a safety bracket 9. The individual screen elements 4 are connected to each other in the area of the projections 14. The uppermost screen element 4 comprises an end surface 12 in form of a reflux valve. The screen elements 4 are secured against sliding out of the guide brackets 3 by means of a safety clamp 5.

A special advantage of the screen basket 2 according to the invention is that the screen elements 4 can be delivered to the assembly place in a prefabricated form and only have to be inserted into the mounted guide angles 3 there. Hereby, the assembly effort is drastically reduced.

1. A screen basket for securing inlets or outlets of tanks, wherein the screen basket comprises two guiding brackets that can be mounted on the container wall and one screen element, on which portions are provided that engage into the guiding brackets, wherein the guiding brackets are positioned with respect to each other such that the screen element can be inserted into the guiding brackets and be fixed above the inlets or outlet.

2. A screen basket according to claim 1, wherein the screen element comprises a screen surface which is essentially parallel to the plane extending between the guiding brackets.

3. A screen basket according to claim 1, wherein the screen element comprises, at least in partial areas, screen surfaces that are anti-parallel with respect to the plane extending between the guiding brackets.

4. A screen basket according to claim 1, wherein at least the screen element is made of synthetic material, preferably polypropylene or a polypropylene blend.

5. A screen basket according to claim 1, wherein the screen element is fixed by means of a safety clamp that can be inserted into the guiding brackets.

6. A screen basket according to claim 1, wherein at least two screen elements are inserted into the guiding brackets and connected to each other.

7. A screen basket according to claim 6, wherein the screen elements are connected to each other by means of a safety clamp, a safety bolt or a weld.

8. A screen basket according to claim 1, wherein the guiding brackets are made of rubber coated steel.
